(19) United States
(12) Patent Application Publication
(10) Pub. No.: US 2014/0371941 A1
(43) Pub. Date: Dec. 18, 2014

(54) SOFTWARE-DEFINED ENERGY COMMUNICATION NETWORKS

(71) Applicant: The Regents of the University of Colorado, a body corporate, Denver, CO (US)

(72) Inventors: ERIC KELLER, Louisville, CO (US); ADAM J. CAHN, Louisville, CO (US); JUAN ESTEBAN HOYOS PAREJA, Boulder, CO (US); MATTHEW HULSE, Boulder, CO (US)

(21) Appl. No.: 14/308,488

(22) Filed: Jun. 18, 2014

Related U.S. Application Data
(60) Provisional application No. 61/836,510, filed on Jun. 18, 2013.

(51) Int. Cl. G05F 1/66

(52) U.S. Cl. CPC G05F 1/66
USPC 700/297

(57) ABSTRACT

Systems and methods are described for software-defined approaches to energy communication networks (ECNs). For example, electrical substations typically host many Intelligent Electronic Devices (IEDs) that monitor and/or control the state of the substations' electricity infrastructures. Critical data from the IEDs can be packaged and transmitted between multiple IEDs for proper system monitoring and control. Even modern networks that interconnect IEDs tend to manifest many limitations, ranging from setup complexity to security policies. Embodiments use novel software-defined networking techniques to address these and other limitations. In some embodiments, power system requirements (e.g., data and communications requirements of IEDs) are translated into a set of networking requirements (e.g., as central routing tables). One implementation uses a Ryu-based, software-defined network controller. Embodiments provide features, such as auto-configuration, security management, re-routing, and flexibility to handle rapid evolution of the smart grid.

### FIELD

Embodiments relate generally to energy infrastructures, and, more particularly, to software-defined energy communication networks for managing energy infrastructures.

### BACKGROUND

Our society has become highly dependent on energy—without it, everything from the light and heat in our homes to the massive datacenters that support the Internet would not be possible. The electrical grid is the complex energy infrastructure that moves electricity from its sources of production (power plants) to its sources of consumption (load centers). The grid is comprised of the network of electrical transmission lines and substations that move energy from one source to another as well as data communication networks that transmit information about energy. These energy communication networks (ECNs) are pervasive and are the essential component in management of the grid.

For more than 20 years, almost all communication between devices inside and outside of power substations has been implemented using copper wires and legacy communication protocols. There were many disadvantages to this approach, including long implementation schedules, the high cost of copper wiring, the lack of monitoring, and the difficulty in performing maintenance. More recently, Ethernet-based systems have been introduced to overcome some of these problems. While the transition to Ethernet is certainly an improvement, it still leaves many problems—namely, the long and arduous process to standardize each individual solution when introducing a new technology (stifling the ability to evolve as needs change) as well as the difficult and error-prone process to manage the network infrastructure.

### BRIEF SUMMARY

Among other things, embodiments described herein include Software-Defined Energy Communication Networks (SDECNs). For example, management and control of the grid involves communication of monitoring and control data among large numbers of intelligent electronic devices (IEDs), which effectively manifests as a set of power system requirements for the grid. Those power system requirements can be translated into a routing table that defines which data are communicated to and from which IEDs. Some implementations of the routing tables can include additional information, such as a geographical location of each IED, which can be used to facilitate additional functionality. The routing tables can be further translated into a set of network requirements specified as a software definition for the SDECN. The IED intercommunications can then be handled as SDN communications. According to this approach, certain embodiments facilitate self-configuration of a substation network, greater levels of automation of distributed power management, IED virtualization, multi-tenant substations, etc.

According to one set of embodiments, a Software-Defined Energy Communication Network (SDECN) is provided. The SDECN includes a software-defined network (SDN) controller, communicatively coupled with a number of intelligent electronic devices (IEDs), each IED configured to monitor and/or control grid components of an electrical power network in such a manner that manifests a set of power system requirements. The SDN controller is configured to: map the set of power system requirements to a set of communications network requirements; and direct operation of the IEDs to monitor and/or control the electrical power network in accordance with the power system requirements by directing communications of the IEDs according to the communications network requirements.

According to another set of embodiments, a method is provided for directing communications in SDECN. The method includes: identifying a set of power system requirements as manifested by a number of intelligent electronic devices (IEDs) configured to monitor and/or control grid components of an electrical power network; mapping the set of power system requirements to a set of communications network requirements; and directing, using a software-defined network (SDN) controller communicatively coupled with the plurality of IEDs, operation of the IEDs to monitor and/or control the electrical power network in accordance with the power system requirements by directing communications of the IEDs according to the communications network requirements.

According to another set of embodiments, a SDN controller is provided that is communicatively coupled with a number of intelligent electronic devices (IEDs) configured to monitor and/or control grid components of an electrical power network. The SDN controller includes a set of processors, and a non-transient, computer-readable storage medium having instructions stored thereon. The instructions, when executed, cause the set of processors to: map a set of power system requirements to a set of communications network requirements, the set of power system requirements manifested by the IEDs according to the manner in which they monitor and/or control the grid components of the electrical power network; and direct operation of the IEDs to monitor and/or control the electrical power network in accordance with the power system requirements by directing communications of the IEDs according to the communications network requirements.

### BRIEF DESCRIPTION OF THE DRAWINGS

The present disclosure is described in conjunction with the appended figures:

FIGS. 1A and 1B show two examples of traditional Energy Communication Networks;

FIG. 2 shows an illustrative Software-Defined Network architecture that includes a control plane in communication with a data plane over an open interface, which can provide a context for various embodiments;

FIG. 3 shows an illustrative Software-Defined Energy Communication Network (SDECN), according to various embodiments;

FIG. 4 shows an illustrative substation architecture as a series of virtual machines in context of a self-configuring Software-Defined Network that interconnects the virtual machines with a power system;

FIG. 5 shows a block diagram of an experimental configuration for evaluation of operational performance for certain features and configuration enhancements of one implementation of an SDECN system built around an SDN network controller in accordance with embodiments described above; and

FIG. 6 shows a flow diagram of an illustrative method for directing communications in a SDECN, according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of various embodiments. However, one having ordinary skill in the art should recognize that the invention can be practiced without these specific details. In some instances, circuits, structures, and techniques have not been shown in detail to avoid obscuring the present invention. While a number of embodiments are described with specific reference to a “grid,” or the like, embodiments operate generally in context of any power network, including, for example, an electrical substation, a photovoltaic array, a wind farm, etc. Further, it will be understood that references to a “network,” or the like, are not intended to limit embodiments to any particular architecture. For example, similar techniques can be employed in context of public or private networks, wired or wireless links, cloud architectures, etc. Even further, reference to “intelligent electronic devices” or “IEDs” is intended to generally include any type of monitoring and/or control devices, such as meters, monitors, etc.

The grid is composed of power generation facilities, high voltage transmission lines, lower-voltage distribution lines and load centers (e.g., residential and commercial buildings). Transmission lines carry electricity at high voltages over large distances, while distribution lines carry electricity at lower voltages to residential and commercial load centers over shorter distances. Transmission and distribution lines are connected by intermediate physical facilities called substations. A substation transforms voltages up and down and has the added, critical responsibilities to constantly measure, monitor, protect and control its section of the grid.

Within a substation, many of the devices used for protection, monitoring and control tend to be proprietary, closed, and inflexible. As networking technologies have advanced, it has become increasingly desirable to have devices interoperate by communicating with one another, which can facilitate distributed intelligence. This is especially the case with newer, network-enabled intelligent electronic devices (IEDs). In the mid-1990s, there were different protocols in the industry; however no single protocol fulfilled all requirements desired by the industry stakeholders. The International Electrotechnical Commission (IEC) Technical Committee (TC) 57 working group began development of a new standard called IEC 61850. The standard intended to define different protocols and the standardize names and functions of substations elements. In 2003, IEC 61850 was released with the stated goal of substation automation. The standard uses abstraction to shield services, communications protocols, and power management devices from each other, which can facilitate device interoperability. As an example, in IEC 61850, devices are assigned meaningful names for reference rather than using cryptic number and letter sequences. The internal, cryptic device names have been abstracted so they can be referenced using human-friendly names.

While IEC 61850 is a forward-thinking standard, not all future requirements were predicted, and technologies quickly changed. The rapid advance of technology and the lengthy standardization process (e.g., some requiring international agreement) have yielded a large gap in unmet needs. For example, the standard was originally designed for intra-substation communication on a LAN (e.g., most of the communication involves layer 2 multicast and flooding). However, a need was recognized for IEDs to communicate between substations. An amended standard (IEC 61850-90-1) was released about five years later to allow for inter-substation communication. However, the technical detail to achieve such communication was unspecified and therefore has tended to involve workarounds or “hacks.” In addition, little attention was given to the security of the substation's network. As an example, it has been demonstrated that a computer can connect to a substation's network and, without any authentication, inject traffic masquerading as a legitimate substation event. Such a security breach in a substation can have far-reaching effects, including the loss of power to major sections of the grid.

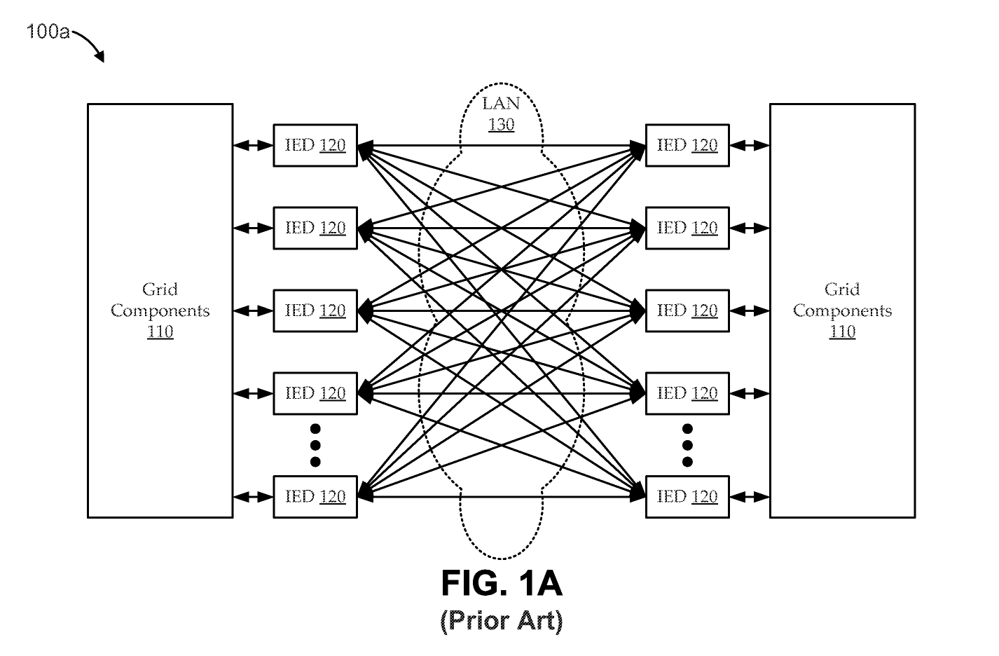

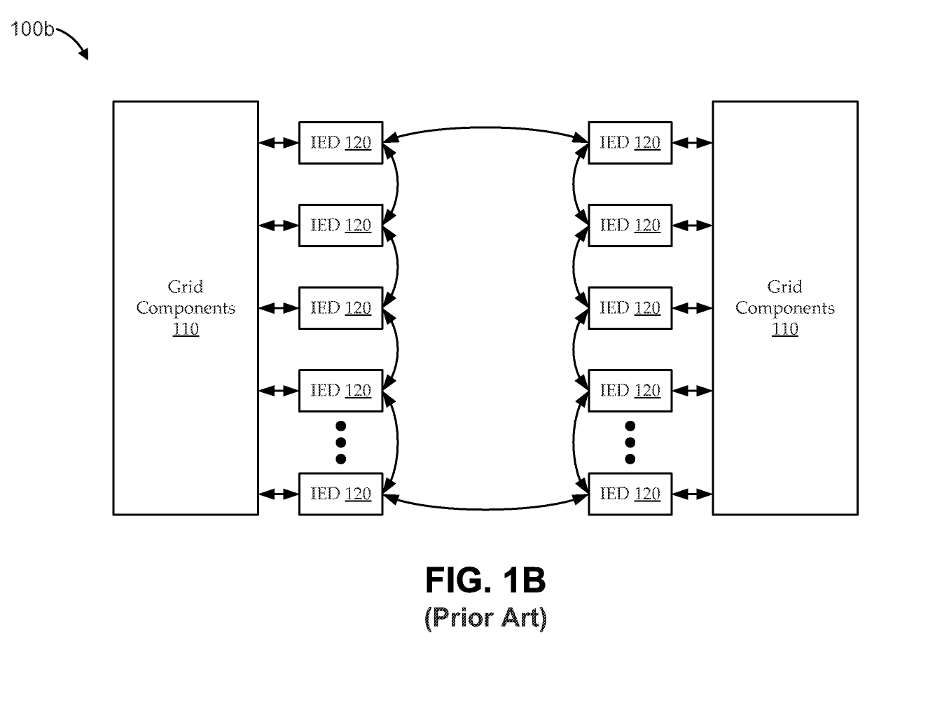

For the sake of illustration, FIGS. 1A and 1B show two examples of traditional ECNs 100. Turning first to FIG. 1A, an ECN 100a is shown having a number of grid components 110. Grid components 110 can generally include any components providing functional support to the electrical grid, including, for example, power lines, cables, circuit breakers, switches, transformers, etc. Monitoring and control of the grid components 110 can be performed using IEDs 120. For example, a typical substation may include fifty IEDs 120, and a large solar power station may include 1,500 IEDs 120. The IEDs 120 are in communication with each other via a LAN 130, or the like. Suppose a first IED 120 senses current at a particular component to detect undesirable current spikes, and a second IED 120 is configured to shut down a particular component when those current spikes are detected.

Some traditional implementations of an ECN 100, like the one illustrated in FIG. 1A, multicast the data from the first IED 120 to all the other IEDs 120 in the ECN 100, and receiving IEDs 120 use multicast filtering or some other technique to ignore data that is not needed by that IED 120. Other traditional implementations of an ECN 100, like the one illustrated in FIG. 1A, use unicast flooding or other techniques to communicate the data, for example, so that the network operator does not have to be aware of IED 120 logical addresses on the network 130.

Turning to FIG. 1B, another ECN 100b is shown having a number of grid components 110. Again, monitoring and control of the grid components 110 is performed using IEDs 120. Unlike in FIG. 1A, the IEDs 120 of FIG. 1B are configured in a ring architecture. Communications from a source IED 120 typically travel either in a clockwise or counter-clockwise direction around the ring until they reach a destination IED 120. These and/or other communications techniques tend to be inefficient, unreliable, and difficult to adapt to changing configurations and/or requirements of the system.

A number of features are desirable in new approaches for ECN management and control, for example, including facilitation of rapid innovation that enables the evolution of both the specialization within each infrastructure as well as integration between them, simplicity of management and verification of the correctness of network operations, improved security of the network, enhanced ability to react to changes in network conditions, etc. Software-defined networking (SDN) is a recent innovation in computer networking that builds intelligence into a network through software control. An SDN-based network can make high-level decisions that impact detailed network functionality, optimizing the network's performance in a manner not easily possible with traditional network management techniques. SDN can be versatile, powerful, and practical. SDN concepts and technologies are available today and have already been implemented on existing network infrastructures, such as Google's backbone network. Even more, solutions to verify network behavior statically and during run-time are facilitated by SDN techniques.

Advances in datacenter network technologies have exploded in part due to open standards, falling equipment prices and embracing of new technologies. As our demand for electricity continues to rise, the trend is to cover this extra demand with renewable, clean energy resources. Such a trend tends to create scenarios where the volatility of these resources increasingly demands new information technology (IT) approaches to avoid blackouts. Incorporation of modern technologies, such as SDN, can help the grid's transformation into a “smart grid.” SDN is a relatively new network architecture which decouples the network intelligence from the network devices.

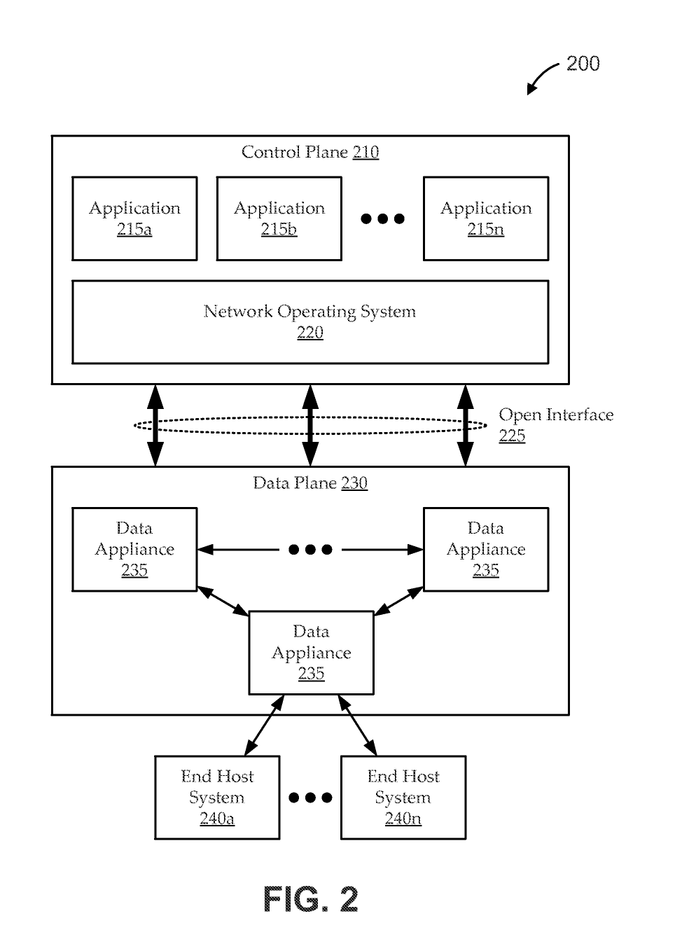

For example, FIG. 2 shows an illustrative SDN architecture 200 that includes a control plane 210 in communication with a data plane 230 over an open interface 225, which can provide a context for various embodiments. As illustrated, the control plane can include a number of functional applications 215 and centralized control provided by a network operating system 220. As used in this context, logically centralized control relates to programming abstraction, even though actual implementations can involve distributed systems to provide extra processing, fault tolerance, etc. Traditionally, network devices run distributed routing protocols and provide an interface to configure the various parameters of those routing protocols on each device. With SDN, software (e.g., applications 215) running on a logically central controller (e.g., network operating system 220) can provide the network intelligence and directly manages a collection of “dumb” forwarding devices through a standard interface. For example, the “dumb” forwarding devices can include a network of data appliances 235 (e.g., switches, routers, etc.) implemented in the data plane 230 of the SDN 200. The data plane 230 can be used to forward data, as appropriate, to one or more end host systems 240. SDN was proposed to overcome the mismatch between what network operators wanted and what network devices provided. For example, for traffic engineering, operators wanted to calculate paths to avoid congestion; whereas with a protocol such as Open Shortest Path First (OSPF), operators determines what link weights would result in OSPF deciding on the desired paths.

Typical implementations of SDNs can exploit the OpenFlow specification, which specifies the communication between each switch and the controller and is supported by many commercially available Ethernet switches. With OpenFlow, each switch can maintain a flow table that is used in the forwarding decision to determine how packets are processed. At a simplified level, the headers of packets are used for a lookup in this table, and the value stored determines the action the switch will take—e.g., forward out a given port, drop the packet, send it to the controller to make the determination, etc. The OpenFlow specification opens access to this table through a communication protocol with an external controller.

SDNs permit production and deployment of software definitions for controlling the network operation. With this key capability, not only do operators have better control over their networks, but new capabilities can be introduced rapidly, which can lead to a more evolvable network.

Network management within a substation can be complex and frustrating for substation operators. The transition from hardwired connections to an Ethernet-based network introduced new functionalities to utilities and the power sector, such as the ability to have distributed data acquisition with distributed intelligence. A substation may contain over one hundred IEDs, with each IED generating and/or consuming information about the status of some aspect of the substation. Proper configuration and maintenance of IED communication can involve significant effort due to the complex message grouping mechanisms, archaic traffic control schemes through VLANs, and the overhead of synchronizing configurations across all publishers, subscribers, and interconnection devices. The network complexity can further increase due to use of multiple protocols, such as IEC 61850 Sample Measure Value (SMV), Generic Object Oriented Substation Event (GOOSE), Manufacturing Message Specification (MMS), Precision Time Protocols (PTP), Distributed Network Protocol (DNP 3.0), proprietary management protocols, etc.

Practical considerations, such as legacy compatibility, architectural complexity, and data criticality, can yield a number of challenges in effective network management. One challenge is that the existing protocols tend to rely heavily on layer 2 multicast. Segregating the multicast traffic and ensuring reliable communications (e.g., avoiding congestion) can involve configuring the network devices with a variety of layer 2 and layer 3 networking functions, like virtual LANs (VLAN), multicast filtering, GARP Multi Registration Protocol (GRMRP), and Multiple MAC (or VLAN) Registration Protocol (MMRP or MMVP). This has been recently identified by engineers as a significant and unquestionable challenge. Other challenges for efficient, reliable, and safe operation of substation networks include traffic complexity, security, congestion, and/or other issues. Embodiments seek to address these and/or other concerns by applying SDN techniques to ECN environments.

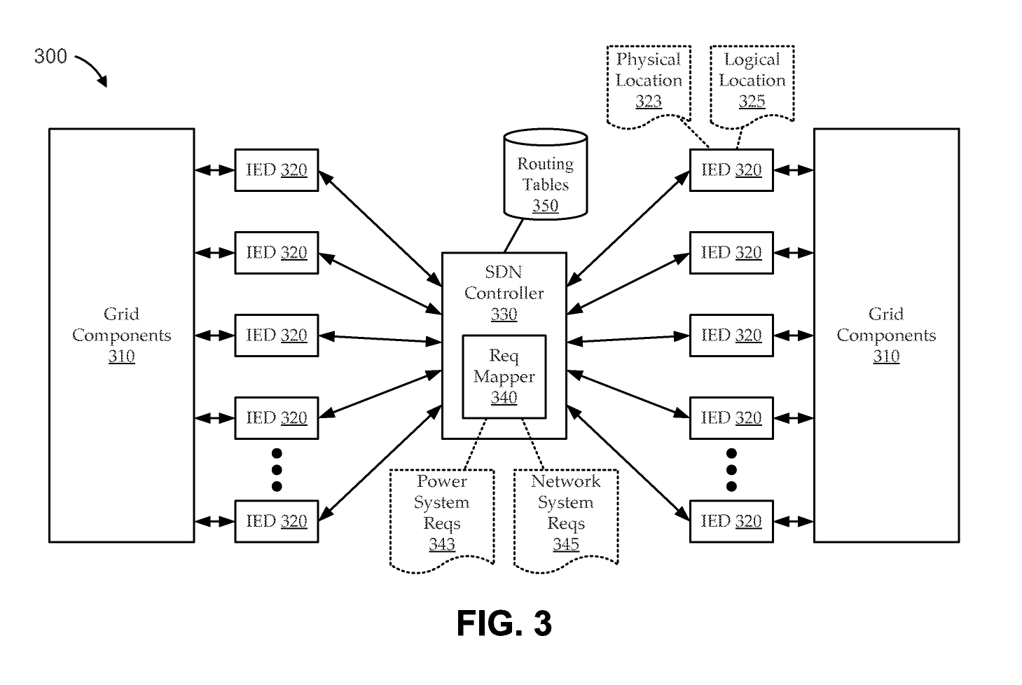

FIG. 3 shows an illustrative Software-Defined Energy Communication Network (SDECN) 300, according to various embodiments. The SDECN 300 includes a number of grid components 310, and monitoring and control of the grid components 310 is performed using IEDs 320. For example, each IED 320 can monitor and/or control the flow and condition of power (e.g., voltage and current levels, noise, etc.), the condition of equipment, etc. Each IED 320 can have an associated physical location 323 (e.g., where the IED 320 is physically located in the grid) and an associated logical location 325 (e.g., a network address or the like). The IEDs 320 are each in communication with an SDN controller 330. In one implementation, the SDN controller 330 is a Ryu-based, software-defined network controller.

Embodiments of the SDN controller 330 include a requirement mapper 340 that operates to map power system requirements 343 to network system requirements 345. The power system requirements 343 can be determined using automated and/or manual processes. As a highly simplified example, the power system requirements 343 can indicate that IED 1 monitors a particular voltage signal, IED 2 monitors a particular current signal, IED 3 balances load for a number of components as a function of the voltage and current signals, and IED 4 disconnects a particular grid component 310 as a function of the current signal. These power system requirements 343 can be mapped to a set of network (e.g., communications) requirements 345. According to the example, IED 1 only needs to communicate to IED 3, IED 2 needs to communicate to both IED 3 and IED 4, and none of the other IEDs need to communicate. A routing table 350 can be generated that routes communications from IED 1 to IED 3, and routes communications from IED 2 to both IED 3 and IED 4. In some embodiments, the routing table 350 also includes information relating to the communications between the IEDs 320 and the grid components 310. For example, certain implementations allow multiple IEDs 320 to selectively communicate with one or more of multiple grid components 310 according to the routing table 350 information.

Though not shown explicitly, implementations include network switches that perform much of the routing functionality. The switches can be implemented internal to and/or external to the IEDs 320. For example, the routing table 350 can represent switch configurations, which can effectively define the software-defined network configuration. For example, referring to FIG. 2, the SDN controller 330 can implement functionality of a network operating system 220, including implementing the routing table 350 to manage configurations of switches and/or other data appliances 235 in the data plane 230 of the architecture.

In some implementations, the SDN controller 330 maintains and/or gathers additional information about the power network. In one implementation, the SDN controller 230 is aware of the physical locations 323 of each IED 320 (e.g., stored in the routing table 350 or in any other suitable manner). For example, the physical location 323 can be used to detect and/or locate misconfigurations, opportunities for routing efficiencies, fraudulent activities (e.g., unauthorized access), etc. Further, the physical location 323 can facilitate hardware maintenance and/or other functions.

As described below, certain embodiments implement the IEDs 320 as virtual machines. For example, each IED 320 can use a flexible hardware and/or software architecture to be configurable for one or more of a number of functions. In one such implementation, redundant IEDs 320 can be used in the case of IED 320 failure. For example, if a voltage-sensing IED 320 fails, another IED 320 can be remotely configured to match the failed IED's 320 functionality, and the routing table 350 can be updated to reroute communications accordingly.

Some embodiments of the SDECN 300 are used to implement a self-managed substation network having a number of illustrative features. One such feature of the self-managed substation network is that the self-managed substation network can be auto-configured. Each new application, protocol, and device adds an extra level of complexity in the network design and maintenance. Traditionally, the power engineers and telecommunication engineers are tasked with configuring the network devices to meet requirements, which tends to be a laborious and error-prone task. Often, each individual IED 320 typically is manually configured to match a network configuration (e.g., which multicast address to use, which port to use, etc.). A single IED 320 can be part of multiple message groups, and, as is often the case, the many IEDs 320 in an operational substation can evolve into a complex logical mesh of message groups. Embodiments of the SDECN 300 support the already-configured IEDs 320 and improve upon the scenario by adding isolation of traffic so that information goes only to where it is meant to go, as described above (e.g., using the routing table 350). The SDN controller 330 can function without maintaining configurations of multiple VLANs for traffic isolation purposes. This complex networking configuration is traditionally replicated across all IEDs 320 and internetwork devices. Implementations of the SDN controller 330 can appreciably reduce overhead relating to configuring layer-2 and layer-3 switches by using configurable software to dynamically create message groups and instantiate new IEDs 320 onto the substation network.

Another such feature of the self-managed substation network is configurable packet inspection. Implementations of the SDN controller 330 facilitate advanced packet management capabilities, which can assist in handling some of the complex traffic profiles seen on substation communication networks. Traffic monitors can be dynamically added as subscribers to existing message groups where they can record and potentially take action upon detecting anomalous events such as a circuit breaker closure or cascading sensor failure. The SDN controller 330 can support the creation and custom configuration of monitoring nodes which can be configured to dynamically adjust message group traffic policies, subscriber lists, or other control functions at the controller level.

Another such feature of the self-managed substation network is security. Link isolation can be desirable, not only for superfluous traffic congestion on IED 320 network interfaces, but also for security and access issues within the operating environment. IED 320 configuration is traditionally carried out “live” when other devices on the substation network are performing monitoring and control of the substation. The risk of a malicious attack, masked as a live-reconfiguration event, is an attack vector that can be addressed with higher degrees of network-level security. Implementations of the SDECN 300 support more security at the SDN controller 330 level. For example, the software-defined control can permit greater flexibility in security policies and access control between connected IEDs 320. A group of devices that are linked through a message group can be configured for one-way communication and only allow the authorized publisher to send traffic into the network. This addresses a common hole in substation network security.

Another such feature of the self-managed substation network is latency-aware, congestion avoidance. Typically, message data on IED 320 networks has an upper-bound of 4 ms latency tolerance as an operational requirement. This window intends to ensure timely delivery of event notifications to subscribers and substation controllers. Violations to these time windows have been linked to substation failure and critical malfunction. As such, the risk of link saturation can be dangerous. IED 320 substation networks deployed in the field often operate near bandwidth capacity. The multi-layered VLAN configurations carry complex traffic loads between unique message groups which risks congestion across the logical layers of the substation network. Avoidance of traffic saturation is difficult to implement in the layer-2 switches traditionally deployed in operational substations, due to the use of minimum-spanning trees which do not provide traffic engineering capability and, even worse, do not utilize the full capacity of the network. Implementations of the SDN controller 330 can facilitate enhanced traffic management and can curtail congestion events (e.g., by redirecting some traffic along alternate paths).

Another feature of the self-managed substation network is traffic monitoring and reconfiguration. Implementations of the SDN controller 330 can receive feedback from components of the SDECN 300 (e.g., from some or all of the IEDs 320) and can reconfigure portions of the network, as appropriate, in response to the feedback. This can be used to provide failure protection (e.g., using dynamic rerouting and/or other techniques) and/or other features. In some implementations, the monitoring functionality includes or facilitates logging and/or auditing functionality. For example, various “monitors” or other similar devices can be added to network nodes to mirror network events and traffic patterns, and other systems (e.g., the SDN controller 330) can execute various control applications, recording tools, etc. driven by the network events and traffic patterns. Certain implementations can couple this functionality with software controls and even APIs to facilitate control applications (e.g., via the SDN controller 330 and/or other devices).

Some embodiments of the SDECN 300 are configured to facilitate virtualization of the network. Traditional IEDs 320 tend to be built around microprocessors that allow the substation operator to control specific, high level monitoring, protection and/or control functions through a rudimentary, vendor-specific user interface. They are typically expensive, inflexible, have limited programmability, and are often designed toward a single purpose. Traditionally, the IEDs 320 contain analog inputs which used to determine the state of attached sensor(s). More recently, Merging Unit (MU) devices have been introduced in limited cases, which simply packetize analog readings in a sample measured value (SMV), for example, over Ethernet. Given the difficulty in network management without this extra traffic, for example as described above, the additional SMV traffic does not typically traverse the substation network. Instead, the MU devices tend to be connected directly to one of the IEDs 320 in the substation.

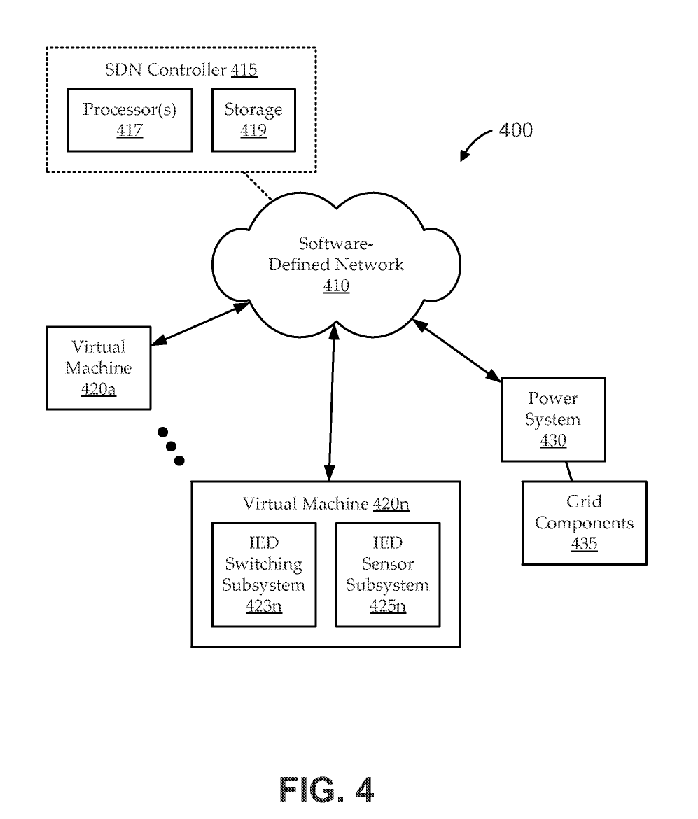

Embodiments of the SDECN 300 implement the functionality of some or all IEDs 320 in the network as software running in a virtual machine (e.g., implemented in commodity computer). For example, FIG. 4 shows an illustrative substation architecture 400 as a series of virtual machines 420 in context of a self-configuring SDN 410 that interconnects the virtual machines 420 with a power system 430. Each virtual machine 420 can include an IED sensor subsystem 425 that includes sensors for measuring attributes, such as current and voltage. Each virtual machine 420 can also include an IED switching subsystem 423 that can packetize the sensor measurements. The virtual machines 420 can be implemented as servers which can process the sensor measurements and communicate the packetized data to the SDN 410.

To fully realize features of the virtual machines 420 (acting as the IEDs), embodiments can automate their respective configurations through centralized control (e.g., at an SDN controller 415). For example, the SDN controller 415 can be communicatively coupled with the virtual machines 420 (e.g., or other types of IEDs) and can include one or more processors 417 and data storage 419 (e.g., implemented as a non-transient, computer-readable storage medium having instructions stored thereon, which, when executed, cause the set of processors to perform functionality described herein). The SDN controller 415 can map a set of power system requirements to a set of communications network requirements, for example, as described above with reference to FIG. 3. The set of power system requirements can be manifested by the plurality of IEDs according to the manner in which they monitor and/or control the grid components 435 of the electrical power network (e.g., power system 430). The SDN controller 415 can also direct operation of the IEDs (e.g., virtual machines 420) to monitor and/or control the electrical power network in accordance with the power system requirements by directing communications of the IEDs according to the communications network requirements. In some implementations, when a substation engineer desires to alter the configuration of the virtualized IEDs (or to perform a system update, or the like), the substation engineer can push relevant configuration information out to the relevant group of IEDs from a single interface within a virtual substation. This can reduce the potential for errors and can save appreciable time and money.

These and other embodiments of SDECNs can provide further virtualization at the network level. For example, SDN techniques can partition network resources among multiple parties and give each full control over its slice of the network (e.g., whether multiple companies or multiple business units within the same company). By applying these techniques in context of virtual IEDs (e.g., and other control software), each substation can be virtualized into a multi-tenant environment.

Virtual substations can be created from one or more physical substations that can be dedicated to a particular customer or utility, a type of energy source (e.g., wind), specific geographic regions or any other logical grouping to meet the changing demands of the energy industry. Doing so can facilitate more cost-effective use of infrastructure resources. Grid infrastructure can be expensive to build, and resources such as transmission lines are often shared among utilities. The owner of the lines derives revenue from multiple utilities that use their lines to transmit electricity. In one illustrative implementation, infrastructure sharing is extended with a virtualized grid that partitions resources and provides independent control over each slice (e.g., implemented effectively as an Infrastructure as a Service (IaaS) cloud computing model). This can open up new avenues for revenue generation as well as utilize computing and network resources more efficiently across the entire power grid. In addition, this virtualized grid can provide increased stability of the physical grid as a whole with its abilities to isolate problems more quickly, provide computational redundancy in an emergency, even spread out CPU processing and balance network traffic.

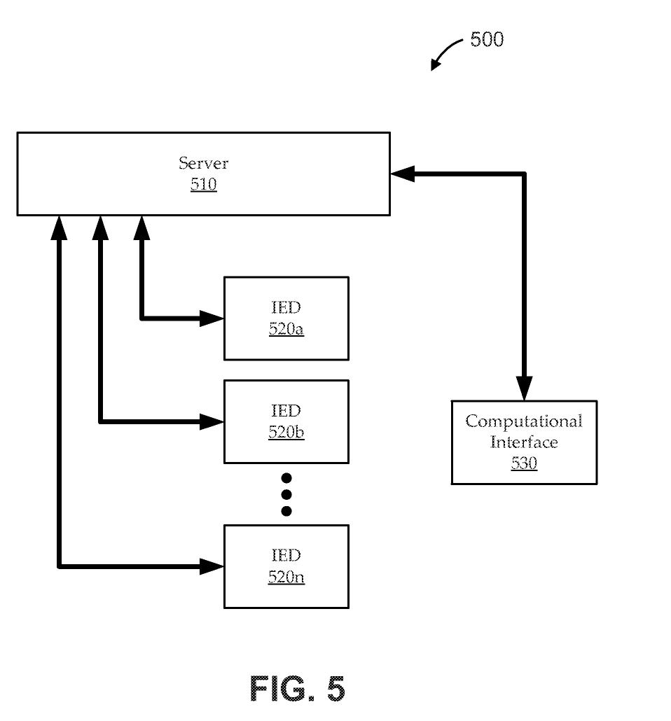

FIG. 5 shows a block diagram of an experimental configuration 500 for evaluation of operational performance for certain features and configuration enhancements of one implementation of an SDECN system built around an SDN network controller in accordance with embodiments described above (e.g., with reference to FIG. 3). Details of the experimental configuration are intended to provide added disclosure and one example implementation, and are not intended to limit the scope of other embodiments. The configuration 500 is built on a Ryu open-sourced network controller and includes three IEDs 520 for testing (e.g., two Schweitzer Engineering Laboratories (SEL) 2411 and one SEL 351 devices). An OpenFlow network topology is emulated on a Dell PowerEdge R710 server 510 with network interface cards, using Mininet to emulate a topology of SDN switches. Each IED 520 can be connected to the server 510 via a respective network interface card, and an additional computational interface 530 (e.g., a laptop) was connected with software to simulate additional IEDs 520 and to run monitoring software. The experimental configuration 500 serves as a test bed for an electrical substation IED network under a software controller that can parse and read configuration files of IEDs 520, dynamically allocate and setup network channels, guarantee efficient and automated networking, support event or traffic monitoring, etc.

The illustrated software controller takes advantage of out-of-the-box support in Ryu for providing a REST API. A Configuration Loader component can implement an asynchronous node creation, discovery, and flow entry method based on data derived from IED device configuration files. The following are some illustrative commands and/or operators that can be used to interact with the prototype network controller:

Add IED(file): A function for adding an IED based on the IED's configuration file containing information relevant to the IED's communication requirements. This function permits the network controller to determine how to configure the network.

Add Monitor(file): A function for adding a virtual node based on a configuration from a text file containing monitor node information. The controller changes the configuration of the network so the monitor can receive the stream of data. If no subscriber list is specified, the monitor will subscribe to all current subscription schemes on the controller.

Del IED(Node ID): A function for removing and unloading an IED configuration based on its Node ID in the controller's runtime configuration.

Del Monitor(Node ID): A function for removing and unloading a virtual monitor node based on its Node ID in the controller's runtime configuration.

Run Monitor(Node ID): Instantiate the call prog logging tool linked to the corresponding Node ID of a monitor node. If the program is located on the system call path, it will begin executing in parallel with the OpenFlow controller and receive message traffic based on its subscriptions.

All these functions can run on-demand when executed on the local controller. A configuration loader module can serve as an application programming interface (API) template for addressing the complex needs of a substation IED network, acting as a bridge between complex IED configuration files, and distilling only their relevant traffic broadcast and subscription information.

To facilitate a smarter, software-enabled controller for substation networks, the experimental configuration 500 can support network management requirements. This includes the ability to address secure switching, complex monitoring of network events and traffic, as well as device discovery by the controller. The capacity to launch an independent monitoring node with a specific traffic or event-logging routine is also supported. Both physical IEDs and virtual monitoring nodes can be placed into the network by the configuration loader module, which can parse an IED configuration to extract information and determine a network configuration to facilitate the specified communication.

One consideration is that, to configure the network, implementations of the controller can be made aware of where the IED is connected in the network (what port of which switch). To automatically determine this, the network controller can attempt discovery of the port location of the device by sending a ping to the device IP address and looking for a “packet-in” event triggered from the IED's response (“packet-in” is an OpenFlow message type where a switch sends a message to the network controller, typically when it receives a packet for which it does not have a table entry; and “packet-in” messages include the port number on which the packet was received). Upon receiving the “packet-in,” the controller can create an entry in its runtime configuration of the device and in the message groups to which it is subscribed.

Secure switching can be built off of the Ryu controller link isolation module. For example, packets can be first identified by the switch port, and the MAC address of the sender can be subsequently derived. This can also facilitate building of flow entries into the switching table used during IED discovery. In a default Ryu implementation, multicast destinations are typically treated as broadcast destinations. This can be undesirable for substation IED networks; so multicast addresses can instead be checked against the ‘subscribers’ list, and a specific dispatch can be created for all matched entries.

Embodiments can rely on shortest path selection, which have been found to result in paths within the latency requirements of the target substation environment. Other embodiments can be expanded to facilitate bandwidth and latency guarantees. This can help ensure isolation of non-subscribers from the message traffic and can allow the multicast addressing scheme function on the same logical network without broadcasting. In classical implementations, isolation of broadcast of messages was accomplished using VLANs, which tended to add significant complexity to the logical network configuration.

To meet the needs of traffic monitoring outside of substation IEDs, the OpenFlow controller can be designed to support development of advanced monitoring programs that can be plugged into a running network. This can facilitate implementation of control applications or recording tools driven by network events and traffic patterns. Embodiments can incorporate the ability to mirror any traffic of interest on a dedicated logging machine called a “Monitor.” Monitors can be added as network nodes and their configuration sets are specified using various techniques. According to one such technique, a “bird-on-the-wire” implementation of monitoring nodes, which supports instantiation of logging applications, can be extended beyond simply running an external program. System calls, or more complex software monitors, can feed configuration changes and traffic policy back into the controller and can facilitate creation of a program/controller API. Such an extension can also permit integration of third-party software.

Such an experimental configuration 500 can substantially match the behavior of a traditional setup that uses legacy Ethernet switches. With the experimental configuration 500 of the SDECN, however, the network did not have to be manually configured, whereas the Ethernet switches and mechanisms, such as multicast filtering, are traditionally set up manually using a cumbersome and error-prone process. Further, changes in configuration can be accomplished in the SDECN without modifying hardware or firmware of any of the switches. Rather, the configuration can be updated by updating the software running on the SDN controller.

As the grid is updated and transformed into a smart grid, the challenges of network management continue to increase. As previously discussed, managing today's substation networks is already becoming overwhelming Embodiments described herein include systems and methods for applying SDN techniques to ECNs, to form novel SDECNs. These SDECNs can yield auto-configuring, secure, reliable power networks. The SDECNs can further facilitate functionality, such as a virtualized grid, and multi-tenant substations.

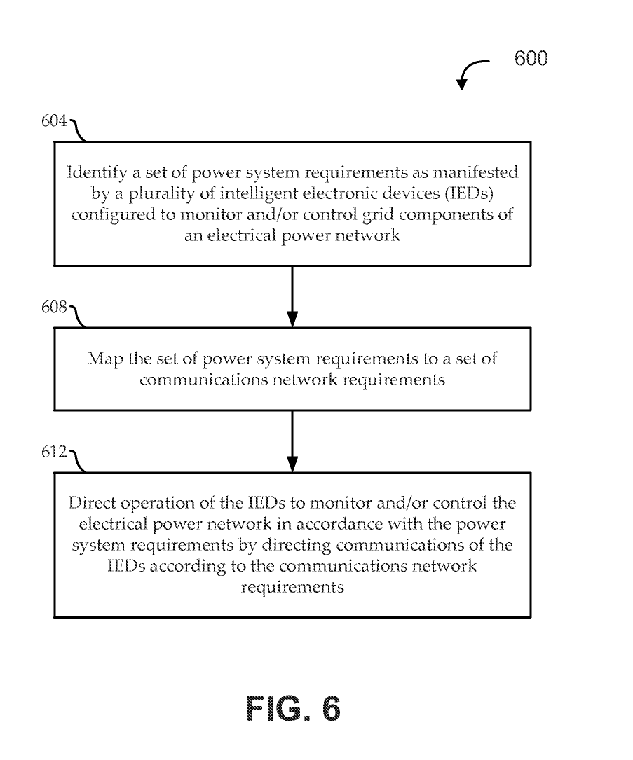

FIG. 6 shows a flow diagram of an illustrative method 600 for directing communications in a SDECN, according to various embodiments. Embodiments of the method 600 begin at stage 604 by identifying a set of power system requirements as manifested by a number of IEDs configured to monitor and/or control grid components of an electrical power network. At stage 608, the set of power system requirements can be mapped (e.g., automatically and/or manually) to a set of communications network requirements. At stage 612, operation of the IEDs can be directed to monitor and/or control the electrical power network in accordance with the power system requirements by directing communications of the IEDs according to the communications network requirements. For example, the directing can be performed by a software-defined network (SDN) controller communicatively coupled with the IEDs.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The various operations of methods and functions of certain system components described above may be performed by any suitable means capable of performing the corresponding functions. The means may include various hardware and/or software component(s) and/or module(s), including, but not limited to a circuit, an application specific integrated circuit (ASIC), or processor. For example, logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm or other functionality described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A Software-Defined Energy Communication Network (SDECN) comprising:
a software-defined network (SDN) controller, communicatively coupled with a plurality of intelligent electronic devices (IEDs), each IED configured to monitor and/or control grid components of an electrical power network in such a manner that manifests a set of power system requirements, the SDN controller configured to:
map the set of power system requirements to a set of communications network requirements; and
direct operation of the IEDs to monitor and/or control the electrical power network in accordance with the power system requirements by directing communications of the IEDs according to the communications network requirements.

2. The SDECN recited in claim 1, wherein the SDN controller is configured to automatically map at least some of the set of power system requirements to the set of communications network requirements, thereby at least partially auto-self-configuring the SDECN.

3. The SDECN recited in claim 1, wherein each IED is configured to monitor and/or control grid components by monitoring power flow of one or more of the grid components, controlling power flow of one or more of the grid components, monitoring power condition of one or more of the grid components, controlling power condition of one or more of the grid components, and/or monitoring equipment condition one or more of the grid components.

4. The SDECN recited in claim 1, wherein the SDN controller is configured to map the set of power system requirements to the set of communications network requirements by generating a network routing table that defines communications routings among the IEDs according to the set of power system requirements.

5. The SDECN recited in claim 4, wherein the network routing table includes a physical location of at least some of the IEDs, each physical location associated with a respective logical location of its IED.

6. The SDECN recited in claim 5, wherein the SDN controller is configured to direct operation of the IEDs further according to their respective physical locations.

7. The SDECN recited in claim 5, wherein the SDN controller is configured to detect at least one of a fraud condition or a routing inefficiency condition according to the physical locations of the IEDs.

8. The SDECN recited in claim 4, wherein the directing operation of the IEDs comprises selectively communicatively coupling multiple of the IEDs with one or more of the grid components according to the network routing table.

9. The SDECN recited in claim 1, wherein the SDN controller is further configured to:
receive feedback from the at least some of the IEDs indicating a change to the set of power system requirements; and
re-map at least some of the set of power system requirements according to the feedback.

10. The SDECN recited in claim 1, wherein the directing communications of the IEDs according to the communications network requirements comprises routing the communications via network switches.

11. The SDECN recited in claim 10, wherein at least one of the network switches is internal to one of the IEDs.

12. The SDECN recited in claim 1, further comprising the plurality of IEDs.

13. The SDECN recited in claim 12, wherein at least some of the IEDs are implemented as virtual machines.

14. The SDECN recited in claim 13, wherein at least one of the virtual machines is a redundant IED that is remotely configurable to selectively perform multiple functions of others of the IEDs.

15. A method for directing communications in a Software-Defined Energy Communication Network (SDECN), the method comprising:
identifying a set of power system requirements as manifested by a plurality of intelligent electronic devices (IEDs) configured to monitor and/or control grid components of an electrical power network;
mapping the set of power system requirements to a set of communications network requirements; and
directing, using a software-defined network (SDN) controller communicatively coupled with the plurality of IEDs, operation of the IEDs to monitor and/or control the electrical power network in accordance with the power system requirements by directing communications of the IEDs according to the communications network requirements.

16. The method recited in claim 15, wherein the mapping comprises the SDN controller automatically mapping at least some of the set of power system requirements to the set of communications network requirements, thereby at least partially auto-self-configuring the SDECN.

17. The method recited in claim 15, wherein the mapping comprises generating a network routing table that defines communications routings among the IEDs according to the set of power system requirements.

18. The method recited in claim 17, wherein the directing operation of the IEDs is performed at least partially in accordance with respective physical locations of the IEDs stored in the network routing table.

19. A software-defined network (SDN) controller communicatively coupled with a plurality of intelligent electronic devices (IEDs) configured to monitor and/or control grid components of an electrical power network, the SDN controller comprising:
a set of processors;
a non-transient, computer-readable storage medium having instructions stored thereon, which, when executed, cause the set of processors to:
map a set of power system requirements to a set of communications network requirements, the set of power system requirements manifested by the plurality of IEDs according to the manner in which they monitor and/or control the grid components of the electrical power network; and
direct operation of the IEDs to monitor and/or control the electrical power network in accordance with the power system requirements by directing communications of the IEDs according to the communications network requirements.

20. The SDN controller recited in claim 19, wherein the storage medium further stores a network routing table that defines communications routings among the IEDs according to the mapping.
